(19) United States
(12) Patent Application Publication
(10) Pub. No.: US 2021/0282016 A1
(43) Pub. Date: Sep. 9, 2021

(54) DENIAL OF SERVICE ATTACK DETECTION AND MITIGATION

(71) Applicant: QUALCOMM Incorporated, San Diego, CA (US)

(72) Inventors: Manikandan Mohan, Chennai (IN); Yashwanth Jayaprakash, Chennai (IN); Subramaninan Anantharaman, Chennai (IN)

(21) Appl. No.: 16/812,047

(22) Filed: Mar. 6, 2020

(51) Int. Cl. H04W 12/12; H04L 29/06

(52) U.S. Cl. CPC H04W 12/1201; H04L 63/1458

(57) ABSTRACT

Wireless communications systems may detect network attacks based on analysis of medium access control (MAC) addresses and origination locations associated with incoming authentication requests. For example, a DoS attack may be detected by determining (e.g., via a database) whether a particular MAC address is associated with multiple authentication request messages without proceeding to an authentication step. According to the described techniques, a system (e.g., an AP, controller/cloud, etc.) may maintain a database of authentication requests and associated MAC addresses, timestamps, and location information. As such, upon reception of an authentication request corresponding to a MAC address, the MAC address may be compared to the database. If the delta (e.g., timestamp difference) between authentication requests from a same MAC address is less than a threshold, the system may detect a potential DoS attack by a client associated with the MAC address and the MAC address may be removed from the AP.

### BACKGROUND

The following relates generally to wireless communications, and more specifically to denial of service (DoS) attack detection and mitigation.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., Institute of Electrical and Electronics Engineers (IEEE) 802.11) network may include one or more access points (APs) that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA (e.g., a user, a client, etc.) may communicate with an associated AP via downlink and uplink. The downlink (or forward link) may refer to the communication link from the AP to the station, and the uplink (or reverse link) may refer to the communication link from the station to the AP.

In some cases, wireless communications systems may be prone to malicious attacks by illegitimate users. For example, in a network attack or a cyber-attack, a perpetrator (e.g., an attacker) may attempt to make a machine (e.g., an AP) or network resources unavailable to its intended users by temporarily or indefinitely disrupting services (e.g., of a host connected to the Internet). In some attacks, AP resources may be heavily utilized in processing of spoofed requests from an attacker (e.g., a malicious STA), and the AP may run out of memory, connectivity and user-experience for legitimate users may be adversely affected, etc. (e.g., which may be particularly detrimental in an enterprise, dense deployments, airports, schools, etc.).

### SUMMARY

The described techniques relate to improved methods, systems, devices, or apparatuses that support denial of service (DOS) attack detection and mitigation. Generally, the described techniques provide for detection of network attacks based on analysis of medium access control (MAC) addresses and origination locations (e.g., location information) associated with incoming authentication requests. For example, a DoS attack may be detected by determining (e.g., via a database, such as a maintained look-up table (LUT)) whether a particular MAC address is associated with multiple authentication request messages without proceeding to an authentication step.

According to the described techniques, a system (e.g., an AP, controller/cloud, etc.) may maintain a database of authentication requests and associated MAC addresses, timestamps, and location information (e.g., positioning information or origination location information associated with the authentication requests). As such, upon reception of an authentication request corresponding to a MAC address, the MAC address may be compared to the database (e.g., to MAC address entries associated with other received authentication requests). If the delta (e.g., timestamp difference) between authentication requests from a same MAC address fails to satisfy a threshold (e.g., a threshold associated with a legitimate effort by a client to proceed to an association step subsequent to the authentication request), the system may detect a potential DoS attack by a client associated with the MAC address. In some examples, the database may further be used to identify other MAC addresses associated with the same location information as an identified attacker, and the other identified MAC addresses may also be removed from the AP (e.g., in cases where an attacker at the identified location is spoofing MAC addresses for multiple DoS attacks).

A method of wireless communications is described. The method may include receiving an authentication request corresponding to a MAC address, comparing the MAC address to a database including one or more MAC address entries associated with other received authentication requests, a timestamp associated with each of the one or more MAC address entries, and location information associated with each of the one or more MAC address entries, detecting a denial of service attack based on the comparison, and discarding the received authentication request based on the detected denial of service attack.

An apparatus for wireless communications is described. The apparatus may include a processor, memory coupled with the processor, and instructions stored in the memory. The instructions may be executable by the processor to cause the apparatus to receive an authentication request corresponding to a MAC address, compare the MAC address to a database including one or more MAC address entries associated with other received authentication requests, a timestamp associated with each of the one or more MAC address entries, and location information associated with each of the one or more MAC address entries, detect a denial of service attack based on the comparison, and discard the received authentication request based on the detected denial of service attack.

Another apparatus for wireless communications is described. The apparatus may include means for receiving an authentication request corresponding to a MAC address, comparing the MAC address to a database including one or more MAC address entries associated with other received authentication requests, a timestamp associated with each of the one or more MAC address entries, and location information associated with each of the one or more MAC address entries, detecting a denial of service attack based on the comparison, and discarding the received authentication request based on the detected denial of service attack.

A non-transitory computer-readable medium storing code for wireless communications is described. The code may include instructions executable by a processor to receive an authentication request corresponding to a MAC address, compare the MAC address to a database including one or more MAC address entries associated with other received authentication requests, a timestamp associated with each of the one or more MAC address entries, and location information associated with each of the one or more MAC address entries, detect a denial of service attack based on the comparison, and discard the received authentication request based on the detected denial of service attack.

Some examples of the method, apparatuses, and non-transitory computer-readable medium described herein may further include operations, features, means, or instructions for determining the MAC address corresponds to one or more other authentication requests associated with the denial of service attack based on the comparison, where the denial of service attack may be detected based on the determination. Some examples of the method, apparatuses, and non-transitory computer-readable medium described herein may further include operations, features, means, or instructions for estimating a time duration between a legitimate authentication request and an association request, determining a first timestamp associated with the received authentication request, and determining a difference between the first timestamp and a second timestamp associated with a previously received authentication request corresponding to the MAC address based on the comparison, where the determination that the MAC address corresponds to the one or more other authentication requests associated with the denial of service attack may be based on the difference being less than the time duration.

Some examples of the method, apparatuses, and non-transitory computer-readable medium described herein may further include operations, features, means, or instructions for blacklisting the MAC address within the database based on the difference being less than the time duration. Some examples of the method, apparatuses, and non-transitory computer-readable medium described herein may further include operations, features, means, or instructions for determining a location associated with the received authentication request based on one or more of a round trip time (RTT) associated with the authentication request, an angle of approach (AoA) associated with the authentication request, a GPS signal associated with the received authentication request, or a cellular network signal associated with the received authentication request.

Some examples of the method, apparatuses, and non-transitory computer-readable medium described herein may further include operations, features, means, or instructions for determining one or more other MAC addresses may be associated with location information that corresponds to the location associated with the received authentication request based on the database, and blacklisting the one or more other MAC addresses based on the determination that the one or more other MAC addresses may be associated with location information that corresponds to the location associated with the received authentication request.

Some examples of the method, apparatuses, and non-transitory computer-readable medium described herein may further include operations, features, means, or instructions for identifying one or more blacklisted MAC addresses based on the database, and determining at least one of the one or more blacklisted MAC addresses may be associated with location information that corresponds to the location associated with the received authentication request based on the database, where the denial of service attack may be based on the determination that at least one of the one or more blacklisted MAC addresses may be associated with location information that corresponds to the location associated with the received authentication request.

Some examples of the method, apparatuses, and non-transitory computer-readable medium described herein may further include operations, features, means, or instructions for updating the database based on the MAC address and the location associated with the received authentication request. In some examples of the method, apparatuses, and non-transitory computer-readable medium described herein, updating the database may include operations, features, means, or instructions for adding a new entry corresponding to the MAC address to the database or updating an existing entry corresponding to the MAC address in the database based on whether the database includes the existing entry corresponding to the MAC address.

Some examples of the method, apparatuses, and non-transitory computer-readable medium described herein may further include operations, features, means, or instructions for receiving a second authentication request corresponding to a second MAC address, determining a first timestamp associated with the received second authentication request, and transmitting an authentication response message in response to the received second authentication request based on a first time duration between the first timestamp and a second timestamp being less than or equal to a threshold, where the second timestamp may be associated with a previously received authentication request corresponding to the second MAC address in the database. Some examples of the method, apparatuses, and non-transitory computer-readable medium described herein may further include operations, features, means, or instructions for removing an entry from the database based on the transmitted authentication response message, where the entry may be associated with the second MAC address. In some examples of the method, apparatuses, and non-transitory computer-readable medium described herein, the threshold may be based on a second time duration between a legitimate authentication request and an association request, a fast initial link setup (FILS) procedure, or a number of connected clients.

Some examples of the method, apparatuses, and non-transitory computer-readable medium described herein may further include operations, features, means, or instructions for comparing the second MAC address to the database, determining that the second MAC address may be unique based on the comparison to the database, and adding an entry associated with the second MAC address to the database based on the determination that the second MAC address may be unique. Some examples of the method, apparatuses, and non-transitory computer-readable medium described herein may further include operations, features, means, or instructions for transmitting (e.g., to a law enforcement agency (LEA)) an indication of the detected denial of service attack, the MAC address, a location associated the received authentication request, or some combination thereof, based on detecting the denial of service attack.

### BRIEF DESCRIPTION OF THE DRAWINGS

FIG. 1 illustrates an example of a system for wireless communications that supports denial of service (DOS) attack detection and mitigation in accordance with aspects of the present disclosure.

FIG. 2 illustrates an example of a wireless communications system 200 that supports DoS attack detection and mitigation in accordance with aspects of the present disclosure.

FIG. 3 illustrates an example of a flow diagram 300 that supports DoS attack detection and mitigation in accordance with aspects of the present disclosure.

FIG. 4 illustrates an example of a process flow 400 that supports DoS attack detection and mitigation in accordance with aspects of the present disclosure.

FIG. 5 illustrates an example of a wireless communication system 500 that supports DoS attack detection and mitigation in accordance with aspects of the present disclosure.

FIGS. 6 and 7 show block diagrams of devices that support DoS attack detection and mitigation in accordance with aspects of the present disclosure.

FIG. 8 shows a block diagram of a communications manager that supports DoS attack detection and mitigation in accordance with aspects of the present disclosure.

FIG. 9 shows a diagram of a system including a device that supports DoS attack detection and mitigation in accordance with aspects of the present disclosure.

FIGS. 10 through 12 show flowcharts illustrating methods that support DoS attack detection and mitigation in accordance with aspects of the present disclosure.

### DETAILED DESCRIPTION

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). In some cases, wireless communications systems may be prone to a large number of denial of service (DoS) attacks (e.g., where attackers may take advantages of network vulnerabilities at the medium access control (MAC) layer). For example, a DoS attack may include a network attack or a cyber-attack where a perpetrator (e.g., an attacker) attempts to make a machine (e.g., an access point (AP)) or network resources unavailable to its intended users by temporarily or indefinitely disrupting services (e.g., of a host connected to the Internet). In a flooding DoS attack (e.g., a distributed denial of service (DDoS) attack), a large number of spoofed authentication requests are transmitted to a victim AP (e.g., or base station), and the AP resources may become consumed in processing of the spoofed requests (e.g., thereby affecting the connectivity and user-experience for legitimate users). When the AP resources are heavily utilized, the AP may run out of memory (e.g., the system may crash) which may be particularly detrimental in an enterprise, dense deployments, airports, schools, etc.

According to the techniques described herein, wireless communications systems (e.g., an AP or a controller/cloud, depending on the implementation) may detect a DDoS attack based on analysis of MAC addresses and origination locations associated with incoming authentication requests. DDoS attacks may be detected by determining (e.g., via a database, such as a maintained look-up table (LUT)) whether a particular MAC address is associated with multiple authentication request messages without proceeding to an authentication step. For example, a system (e.g., an AP, controller/cloud, etc.) may maintain a database of authentication requests and associated MAC addresses, timestamps, and location information (e.g., positioning information or origination location information associated with the authentication requests). If the delta (e.g., timestamp difference) between authentication requests from a same MAC address is less than a threshold (e.g., a threshold associated with a legitimate effort by a client to proceed to an association step subsequent to the authentication request), the system may detect a potential DDoS attack by a client associated with the MAC address. In other words, if the delta (e.g., time difference) between authentication requests from a same MAC address is less than a threshold, the system may determine the MAC address may correspond to one or more other authentication requests that may be associated with the DDoS attack, and the client may be removed from the AP (e.g., and the MAC address may backlisted in the database).

In some examples, before the client is removed from the AP, the angle of arrival (AoA) and the round trip time (RTT) of the authentication requests may be determined. As such, subsequent messages coming from the same location may be discarded (e.g., in case of subsequent or additional authentication requests coming from the same attacker, in the same location, spoofing a different MAC address). For instance, upon detection of a DDoS attack, the location of the attacker (e.g., the AoA, RTT, etc. of the authentication requests triggering detection of the DDoS attack) may be compared to the database. In some cases, other MAC address that are associated with the same location information may be flagged and blacklisted (e.g., as other MAC addresses in the same location may suggest potential MAC address spoofing by an attacker).

Aspects of the disclosure are initially described in the context of example wireless communications systems. Example flow charts and process flows illustrating aspects of the discussed techniques are then described. Aspects of the disclosure are further illustrated by and described with reference to apparatus diagrams, system diagrams, and flowcharts that relate to DoS attack detection and mitigation

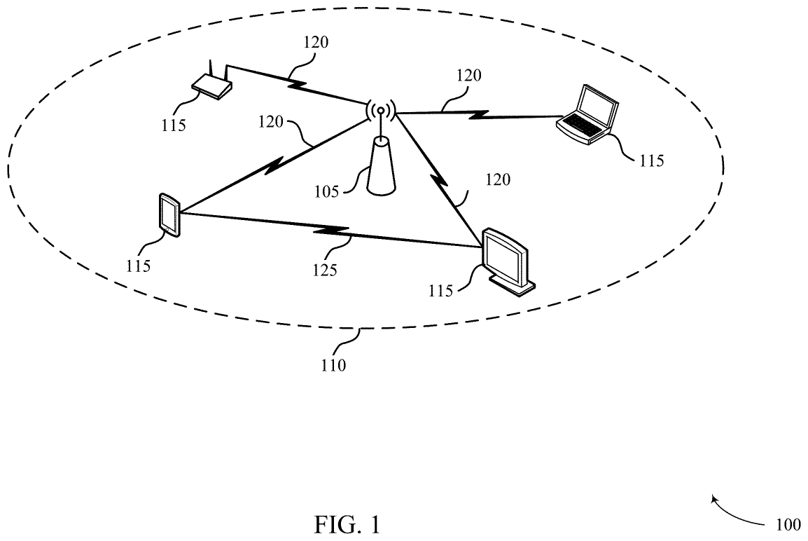

FIG. 1 illustrates a wireless communications system 100 (e.g., a wireless local area network (WLAN), also known as a Wi-Fi network) configured in accordance with various aspects of the present disclosure. The wireless communications system 100 may include an AP 105 and multiple associated STAs 115, which may represent devices such as mobile stations, personal digital assistant (PDAs), other handheld devices, netbooks, notebook computers, tablet computers, laptops, display devices (e.g., TVs, computer monitors, etc.), printers, etc. The AP 105 and the associated stations 115 may represent a BSS or an ESS. The various STAs 115 in the network are able to communicate with one another through the AP 105. Also shown is a coverage area 110 of the AP 105, which may represent a BSA of the wireless communications system 100. An extended network station (not shown) associated with the wireless communications system 100 may be connected to a wired or wireless distribution system that may allow multiple APs 105 to be connected in an ESS.

Although not shown in FIG. 1, a STA 115 may be located in the intersection of more than one coverage area 110 and may associate with more than one AP 105. A single AP 105 and an associated set of STAs 115 may be referred to as a BSS. An ESS is a set of connected BSSs. A distribution system (not shown) may be used to connect APs 105 in an ESS. In some cases, the coverage area 110 of an AP 105 may be divided into sectors (also not shown). The wireless communications system 100 may include APs 105 of different types (e.g., metropolitan area, home network, etc.), with varying and overlapping coverage areas 110. Two STAs 115 may also communicate directly via a direct wireless link 125 regardless of whether both STAs 115 are in the same coverage area 110. Examples of direct wireless links 120 may include Wi-Fi Direct connections, Wi-Fi Tunneled Direct Link Setup (TDLS) links, and other group connections. STAs 115 and APs 105 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within wireless communications system 100.

In some cases, a STA 115 (or an AP 105) may be detectable by a central AP 105, but not by other STAs 115 in the coverage area 110 of the central AP 105. For example, one STA 115 may be at one end of the coverage area 110 of the central AP 105 while another STA 115 may be at the other end. Thus, both STAs 115 may communicate with the AP 105, but may not receive the transmissions of the other. This may result in colliding transmissions for the two STAs 115 in a contention based environment (e.g., CSMA/CA) because the STAs 115 may not refrain from transmitting on top of each other. A STA 115 whose transmissions are not identifiable, but that is within the same coverage area 110 may be known as a hidden node. CSMA/CA may be supplemented by the exchange of an RTS packet transmitted by a sending STA 115 (or AP 105) and a CTS packet transmitted by the receiving STA 115 (or AP 105). This may alert other devices within range of the sender and receiver not to transmit for the duration of the primary transmission. Thus, RTS/CTS may help mitigate a hidden node problem. Generally, as used herein, STA 115, client (e.g., client 205), user, etc. may be used interchangeably.

As described herein, wireless communications system 100 (e.g., an AP 105) may detect network attacks based on analysis of MAC addresses and origination locations (e.g., location information) associated with incoming authentication requests. For example, a DoS attack may be detected by determining (e.g., via a database, such as a maintained LUT) whether a particular MAC address is associated with multiple authentication request messages without proceeding to an authentication step. According to the described techniques, a system (e.g., an AP 105, controller/cloud, etc.) may maintain a database of authentication requests and associated MAC addresses, timestamps, and location information (e.g., positioning information or origination location information associated with the authentication requests). As such, upon reception of an authentication request corresponding to a MAC address, the MAC address may be compared to the database (e.g., to MAC address entries associated with other received authentication requests). If the delta (e.g., timestamp difference) between authentication requests from a same MAC address is less than a threshold (e.g., a threshold associated with a legitimate effort by a client, or STA 115, to proceed to an association step subsequent to the authentication request), the system may detect a potential DoS attack by a client (e.g., a STA 115) associated with the MAC address. In some examples, the database may further be used to identify other MAC addresses associated with the same location information as an identified attacker, and the other identified MAC addresses may also be removed from the AP 105 (e.g., in cases where an attacker at the identified location is spoofing MAC addresses for multiple DoS attacks).

In some additional or alternative examples, wireless communications system 100 may detect a potential DoS attack by a client (e.g., a STA 115) associated with the MAC address based on the delta between authentication requests from the MAC address being greater than a threshold. For example, if the delta between a first authentication request associated with a MAC address and a subsequent authentication request associated with the MAC address is greater than the threshold, wireless communications system 100 (e.g., an AP 105) may detect a potential attack (e.g., a DoS attack, a DDoS attack, etc.) by a client (e.g., a STA 115) associated with the MAC address. In other words, if the delta between a first authentication request of a client and a subsequent authentication request of the client is greater than a threshold, the client may not be attempting to move to an association step, so the system may determine that the client is associated with an attack, and the client may be removed from the AP.

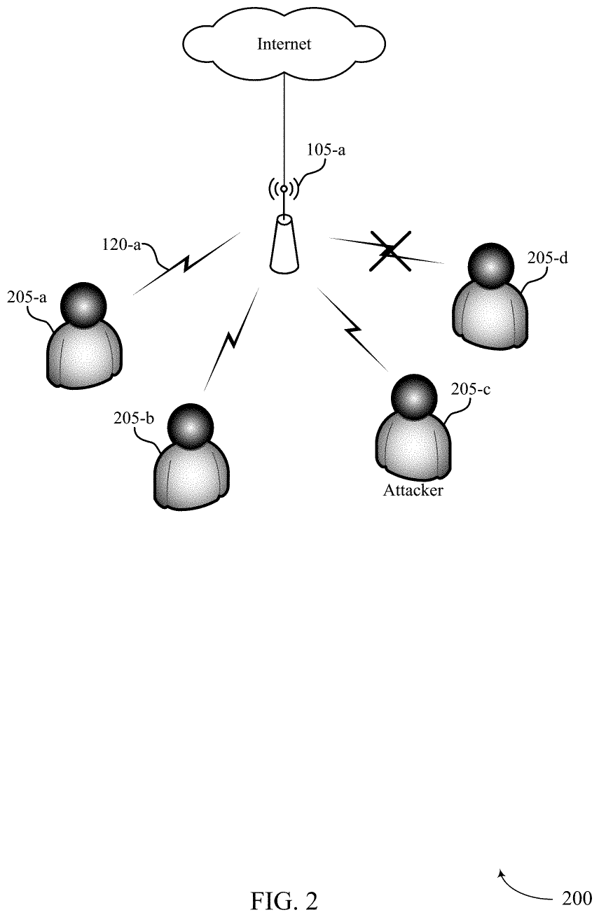

FIG. 2 illustrates an example of a wireless communications system 200 that supports DoS attack detection and mitigation in accordance with aspects of the present disclosure. In some examples, wireless communications system 200 may implement aspects of wireless communications system 100, as described with reference to FIG. 1. The wireless communications system 200 may include an AP 105-a that supports communication with multiple clients or STAs 115 (e.g., client 205-a, client 205-b, client 205-c, and client 205-d) within a supported geographic coverage area. Generally, wireless communications system 200 illustrates an example where AP 105-a may act as a serving or source AP (e.g., base station) for clients 205-a through 205-d.

In some cases, wireless communications system 200 may be prone to a large number of DoS attacks (e.g., where attackers may take advantages of network vulnerabilities at the MAC layer). For example, a DoS attack may include a network attack or a cyber-attack where a perpetrator (e.g., an attacker, such as client 205-c) attempts to make a machine (e.g., AP 105-a) or network resources of wireless communications system 200 unavailable to its intended clients 205-a, 205-b, and 205-d by temporarily or indefinitely disrupting services. In a flooding DoS attack (e.g., a DDoS attack), a large number of spoofed authentication requests are transmitted to victim AP 105-a, and AP 105-a resources may become consumed in processing of the spoofed requests (e.g., thereby affecting the connectivity and user-experience for legitimate users). When AP 105-a resources are heavily utilized, AP 105-a may run out of memory (e.g., the wireless communications system 200 may crash) which may be particularly detrimental in an enterprise, dense deployments, airports, schools, etc.

In some cases, wireless communications system 200 may detect and stop attacks (e.g., network attacks or cyber-attacks, such as DoS attacks, DDoS attacks, etc.). For example, AP 105-a may maintain a database (e.g., a LUT) that contains data entries associated with authentication requests, clients, MAC addresses, timestamps, locations information, or any combination thereof. In some cases, the timestamp associated with a data entry in the database may be based on the time at which the authentication request was sent. An authentic user or client (e.g., client 205-a) may move on to an association phase after an authentication phase, and clients which are associated with an attack (e.g., client 205-c) may stay in the authentication phase. In some cases, an attacker may engage in a distributed attack (e.g., a DDoS), simulate one or more client devices (e.g., client 205-b), and send authentication requests from the simulated device. The AP 105-a may detect the inauthentic requests sent from the one or more simulated client devices, and refrain from responding to the requests.

In some cases, an attacker (e.g., client 205-c) may remain in an authentication phase with AP 105-a, and the attacker may consume the resources of AP 105-a. For example, an authentic client (e.g., client 205-d) may be unable to connect to AP 105-a, as AP 105-a may not have the resources available to establish a connection with the authentic client (e.g., as AP 105-a may become consumed with processing of spoofed requests from an attacking client 205-c). In some cases, AP 105-a may crash, become delayed, or become otherwise inoperable, and authentic clients (e.g., client 205-d) may be unable to connect to the AP 105-a. The techniques described herein may detection and removal of inauthentic clients (e.g., an attacker, such as client 205-c, etc.) such that authentic clients (e.g., client 205-a, client 205-b, client 205-d) can connect and/or communicate with AP 105-a. The detection and removal of inauthentic clients may improve system speed and reliability.

When a new authentication request is sent from the same client MAC address, AP 105-a may check for an entry in the database that is associated with the MAC address. If there is a matching entry in the database, and a delta between a current timestamp and a timestamp present in the database crosses a threshold, the client may be kicked from AP 105-a (e.g., the MAC address associated with the client may be added to a blacklist, and AP 105-a may not respond to requests from the client). In some cases, AP 105-a may detect location information (e.g., AoA, physical location, RTT, etc.) of the authentication request. AP 105-a may traverse or otherwise inspect the database for clients associated with location information that is the same as or similar to the location information of the client that was kicked from AP 105-a. If clients are found with similar location information, AP 105-a may identify the clients as being associated with the kicked client, and AP 105-a may refrain from responding to requests (e.g., authentication requests) sent from the clients. In some case, AP 105-a may detect a malicious client (e.g., a client sending inauthentic requests), locate an attacker (e.g., client 205-c) based on location information (e.g., AoA, RTT, etc.) associated with the malicious client, and may discard requests sent from clients that are associated with the location information. For instance, if AP 105-a receives a subsequent authentication request, from a new MAC address, that is associated with the same location information as client 205-c, the new MAC address may be blacklisted (e.g., as client 205-c may be spoofing MAC addresses).

In some examples, the techniques described herein may be combined with positioning (e.g., localization and context awareness) techniques. For instance, location information may be based on a global navigation satellite system (GNSS), terrestrial beacon systems (TBS), inertial measurement units (IMUs), Wi-Fi measurements, Bluetooth measurements, fifth generation (5G) localization technologies, or any combination thereof. The location information described herein may provide high precision positioning and support the identification of inauthentic clients 205 (e.g., attackers). In some examples, an inauthentic client 205 may be blacklisted based on the location information associated with the client 205, and an authentic client 205 may not be blacklisted. For example, the high precision positioning information may indicate a precise location of a client 205, and the high precision location information may be used by a device (e.g., an AP 105) to distinguish inauthentic clients 205 from authentic clients 205. In some additional or alternative examples, the use of high precision location information may prevent the removal (e.g., blacklisting) of authentic clients 205, thereby improving system integrity (e.g., of wireless communications system 200).

According to the techniques described herein, wireless communications system 200 (e.g., AP 105-a or a controller/cloud, depending on the implementation) may detect a network attack by client 205-c based on analysis of MAC addresses and origination locations associated with incoming authentication requests. DDoS attacks may be detected by determining (e.g., via a database, such as a maintained LUT) whether a particular MAC address is associated with multiple authentication request messages without proceeding to an authentication step.

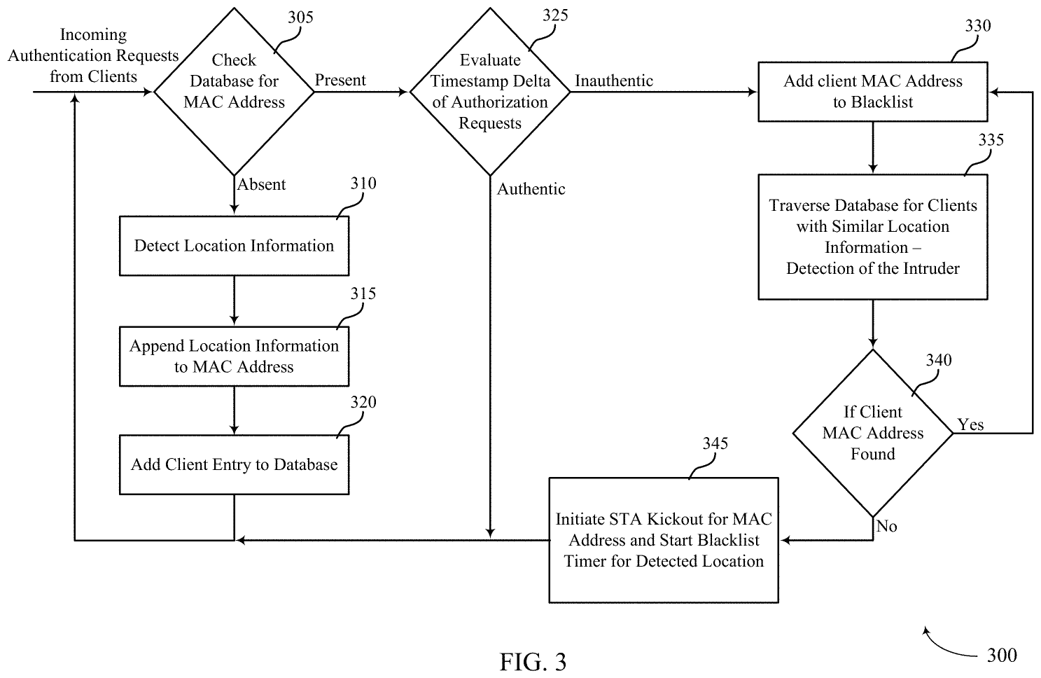

FIG. 3 illustrates an example of a flowchart 300 that supports DoS attack detection and mitigation in accordance with aspects of the present disclosure. In some examples, flowchart 300 may implement aspects of wireless communications system 100 and/or wireless communications system 200. Flowchart 300 may illustrate detection (e.g., by an AP and/or a controller/cloud, depending on the implementation) of network attacks based on analysis of MAC addresses and origination locations associated with incoming authentication requests.

At 305, a device (e.g., an AP, a controller, etc.) may receive an authentication request from a client (e.g., a STA, a user equipment (UE), etc.) that is associated with a MAC address, and the device may check a database (e.g., a LUT) for entries that correspond to the MAC address. In some cases, the MAC address may be present in the database, and in alternative examples, the MAC address may not be present in the database. When the MAC address, or a client entry associated with the MAC address, is not present in the database the device may proceed to 310.

At 310, the device may detect location information associated with the client. In some cases, the device may detect location information based on an AoA and/or a physical location of the client. In some examples, the device may detect location information based on an RTT of the authentication request. In some additional or alternative cases, the device may detect location information based on a localization technique. In some examples, the device may detect location information based on a propagation delay (e.g., a time difference of arrival (TDOA) and/or device to device (D2D) communications (e.g., cooperative localization). Generally the device may use various techniques for detecting location information associated with the client (e.g., such as global positioning system (GPS) information, satellite information, AoA information, RTT information, received signal power information, GNSS information, TBS information, 5G positioning information, time of flight (ToF) information, etc.).

At 315, the device may append or otherwise associate the location information with the MAC address. For example, the device may create or identify a client entry corresponding to the MAC address and associate the location information with the client entry.

At 320, the device may add the client entry to the database. In some cases, the device may add the client entry to a LUT table. In some cases, the database may not contain a client entry associated with the MAC address, and the device may create a client entry that is associated with the MAC address in the database. In some additional or alternative cases, the database may contain a client entry associated with the MAC address, and the device may identify the client entry that is associated with the MAC address. The device may add the created or identified client entry to the database.

When the MAC address is present in the database (e.g., an entry exists in the database that is associated with the MAC address), the device may proceed to 325. At 325, the device may evaluate a timestamps (e.g., a difference or delta between timestamps) of authentication requests associated with the MAC address. In some cases, the timestamp delta may be calculated based on a time difference of a timestamp associated with an authentication request and a timestamp associated with a database entry (e.g., corresponding to a previously received authentication request from the same MAC address). For example, an authentication request may be received by the device, and the authentication request may be associated with a MAC address and a timestamp. The device may identify an entry in the database that is associated with the same MAC address and a different timestamp, and the device may calculate a timestamp delta based on a difference between the timestamps.

In some cases, the timestamp delta may be used in determining whether the authentication request is an authentic or inauthentic request. For example, in some cases, if the delta is greater than a threshold, the device may identify the request as inauthentic and add the associated MAC address to a blacklist. If the delta is less than or equal to the threshold, the device may identify the request as authentic and refrain from adding the associated MAC address to the blacklist. In other examples, if the delta is less than a threshold the device may identify the request as in authentic. Generally, the device may detect a potential attack (e.g., a DoS attack, a DDoS attack, etc.) by the client associated with the MAC address based on an analysis of entries in the database or LUT (e.g., of timestamps corresponding to sequential authentication requests, where various thresholds may be used for such detection based on the implementation).

The threshold may be configured by a serving device (e.g., an AP), a network device (e.g., controlling device), written standards, or the like. In some cases, the threshold may be determined by a time delta of authentic requests, an average time delta of authentic requests, the number of clients that can potentially connect to the device, the number of clients that are connected to the device, system parameters, a link procedure (e.g., fast initial link setup (FILS), or any combination thereof. For example, in some cases, the threshold may be based on a time an AP takes to assign an internet protocol (IP) address for a client (e.g., if a subsequent authentication request is received with a delta less than the time the AP takes to assign an IP address for the client, the subsequent authentication request may be associated with a network attack). Generally, the threshold may be determined based on information indicative of whether a client is saying in an authentication request stage versus legitimately trying to proceed to a next authentication stage (e.g., an association stage).

In some case, the device may determine that the authentication request is inauthentic and proceed to 330. At 330, the device may add the MAC address to a blacklist. For example, the device may associate the MAC address (e.g., the client) with inauthentic authentication requests and/or a DoS attack. In some case, the device may ignore future authentication requests that are associated with the MAC address. Further, in some examples, the device may update location information associated with the MAC address (e.g., in some cases, the device may repeat steps 310 and 315 after 325, and the device may update the client entry in the database accordingly).

At 335, the database may be traversed (e.g., searched) for clients with similar location information to that of the blacklisted client (e.g., the database may be traversed to detect intruders, malicious users, clients associated with a DoS attack, etc.). At 340, the device may determine whether a MAC address was found in the table with a similar physical location to that of the blacklisted client. If a MAC address is found with a similar detected location, the device may blacklist the found MAC address. For instance, advanced positioning techniques may be implemented to precisely determine location information for a client (e.g., MAC address) associated with a detected network attack. As such, a device or cloud (e.g., an AP) may search the database for other MAC addresses with the same location information (e.g., MAC addresses in the database with the same AOA and RTT) and add any entries with matching location information to the blacklist.

At 345, the device may initiate a client (e.g., STA) kickout and/or start a timer (e.g., a blacklist timer) for the detected location. In some cases, the device may ignore authentication requests that are from the detected location, or within a range of the detected location, while the blacklist timer is running. Ignoring requests from the detected location may improve device performance and mitigate the effects of a DoS attack, thereby improving system reliability. For example, in cases where a malicious attacker spoofs multiple MAC addresses, attacks the network from multiple devices, etc., blacklisting authentication requests from a precise location may mitigate the effects of such attacks.

In some examples, the device may further notify a law enforcement agency (LEA) or other governing body upon detection of such an attack. For instance, the device (e.g., or system, cloud, etc.) may report one or more MAC address associated with a detected network attack to an external body or source. In some cases (e.g., in cases where advanced positioning techniques are implemented), the device may further notify such an external body of location information associated with a detected network attack. As such, in some cases, the techniques described herein may be used for identification of location information associated with network attacks, which may be used to identify a geographical location of an attacker.

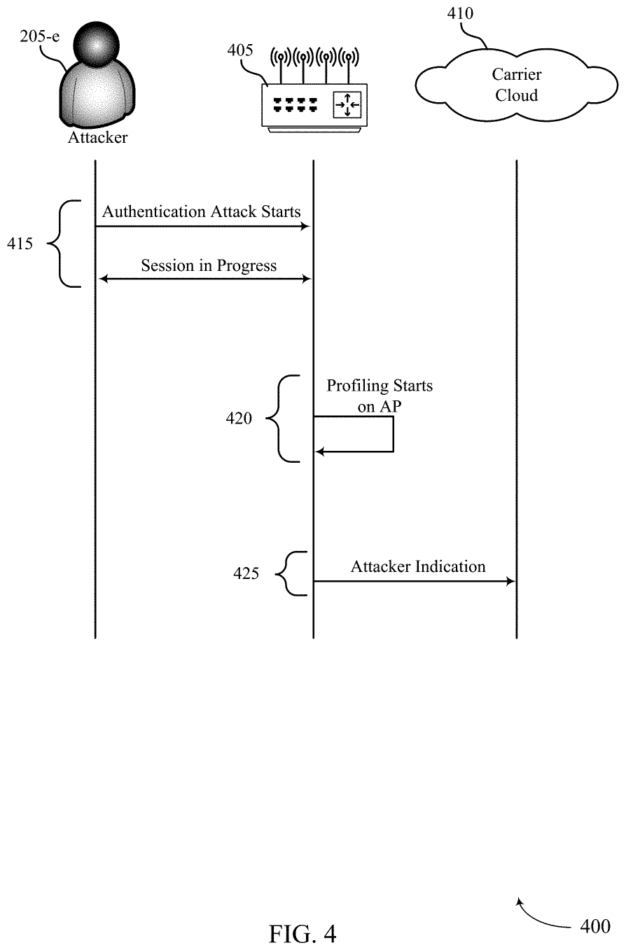

FIG. 4 illustrates an example of a process flow 400 that supports DoS attack detection and mitigation in accordance with aspects of the present disclosure. In some examples, process flow 400 may implement aspects of wireless communications system 100, wireless communications system 200, and/or flowchart 300. According to the techniques described herein, process flow 400 may illustrate detection of network attacks at an AP or home mesh (e.g., at router 405 and carrier cloud 410) based on analysis of MAC addresses and origination locations associated with incoming authentication requests.

In some cases, a client 205 (e.g., attacking client 205-e) may start an authentication attack (e.g., a DoS attack). For example, at 415, attacking client 205-e may target a home Wi-Fi network with a DoS attack. In some examples, attacking client 205-e may target a device (e.g., a router 405) associated with the Wi-Fi network, and the attacker may begin transmitting authentication requests to the device. At 420, the device (e.g., an AP) may start profiling the authentication requests, and in some cases, the device may detect the attack (e.g., detect a “real” attack, detect a DoS attack, detect a DDoS attack, etc.) on the Wi-Fi network (e.g., the AP may maintain and manage the database for analysis of authentication requests as described herein).

At 425, the device (e.g., the router 405) may notify the network (e.g., a carrier cloud 410) and/or a LEA about the attack. In some cases, the device may include location information in the notification. For example, information such as AoA, RTT, AP triangulation with assisted GPS, other geo-tags, or any combination thereof may be included in the notification. In other words, upon detecting a network (e.g., DoS) attack, a device (e.g., an AP 105, router 405, etc.) or a system (e.g., the network) may transmit an indication of the detected network attack, the MAC address associated with the detected network attack, a location associated the received authentication request, or any combination thereof. The indication may be transmitted to a LEA, an administrator, a governing body, an enterprise manager, etc. In some cases, the information included in the notification may be based on a desired location precision and/or cost. For example, positioning techniques implemented by the system (e.g., by an AP, router 405) may depend on complexity and/or cost considerations (e.g., more advanced measurements of location may be conducted and included in the notification if the precision of the location is an important factor, and less advanced measurements of location may be conducted and included in the notification if cost is an important factor).

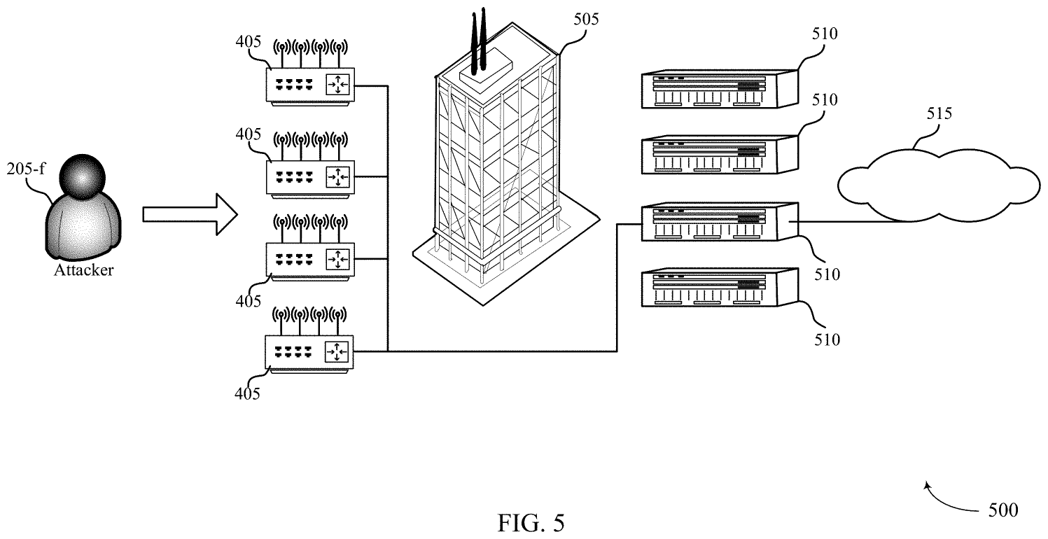

FIG. 5 illustrates an example of a network security diagram 500 that supports DoS attack detection and mitigation in accordance with aspects of the present disclosure. In some examples, network security diagram 500 may implement aspects of wireless communications system 100, wireless communications system 200, flowchart 300, and/or process flow 400. According to the techniques described herein, process flow 400 may illustrate detection of network attacks at cloud or controller (e.g., at controller environment 510 and cloud 515) based on analysis of MAC addresses and origination locations associated with incoming authentication requests.

A user (e.g., attacking client 205-f) may target one or more routers 405. In some cases, the targeted routers (e.g., routers 405) may be associated with a home (e.g., residential) network or an enterprise network (e.g., enterprise building 505 or enterprise Wi-Fi deployment). The attacking client 205-f may target the routers 405 with a flooding of inauthentic authentication requests (e.g., a DoS attack). In some cases, the targeted routers may pass on (e.g., transmit) the authentication requests, or information associated with the authentication requests (e.g., the number of requests, the type of requests, the frequency of requests, the location of the requests, etc.) to controllers 510.

A number of controllers 510 may be connected to the cloud 515. In some cases, a controller 510 may process or construct a centralized view of the attacks (e.g., DoS attacks, DDoS attack, etc.) on the routers 405. For example, the controller 510 may receive attack information (e.g., MAC addresses associated with authentication requests, authentication request frequency, location information associated with authentication requests, etc.), determine that an attack is occurring, and prevent this attack from continuing (e.g., blacklisting the MAC addresses associated with the attack).

In some cases, a controller 510 may detect the routers 405 that are being attacked and the percentage of impairment of each router 405 (e.g., a percentage of available resources). The controller 510 may, in some cases, initiate actions on a per router basis (e.g., an enterprise controller environment may detect specific APs and percentage of impairment, or percentage availability, of each AP and initiate action on a per-AP basis). For example, if a first router 405 is receiving a flood of authentication requests, the router 405 may have very little available resources, and the controller 510 may blacklist authentication requests to the first router 405 or take the first router 405 off the network. In some cases, a controller 510 may pass on (e.g., transmit) location information associated with attacking client 205-f to a LEA. A controller's ability to derive a network's topology and resource usage may improve attacker identification and network resource availability.

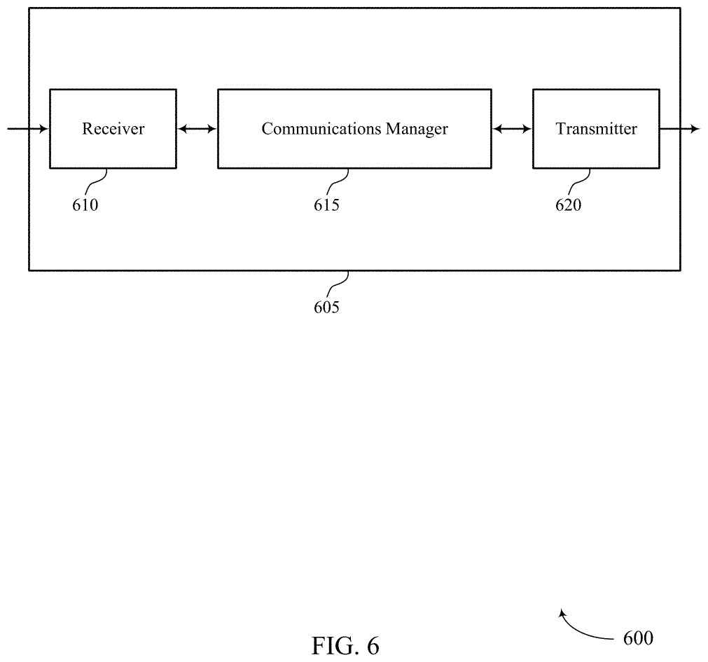

FIG. 6 shows a block diagram 600 of a device 605 that supports DoS attack detection and mitigation in accordance with aspects of the present disclosure. The device 605 may be an example of aspects of a AP as described herein. The device 605 may include a receiver 610, a communications manager 615, and a transmitter 620. The device 605 may also include a processor. Each of these components may be in communication with one another (e.g., via one or more buses).

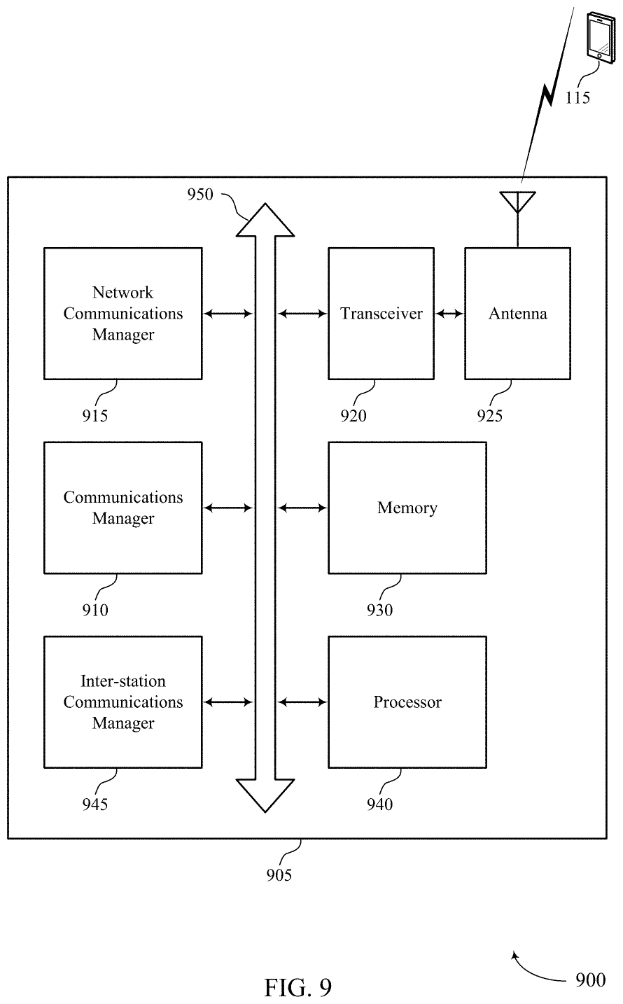

The receiver 610 may receive information such as packets, user data, or control information associated with various information channels (e.g., control channels, data channels, and information related to DoS attack detection and mitigation, etc.). Information may be passed on to other components of the device. The receiver 610 may be an example of aspects of the transceiver 920 described with reference to FIG. 9. The receiver 610 may utilize a single antenna or a set of antennas.

The communications manager 615 may receive an authentication request corresponding to a MAC address, discard the received authentication request based on the detected denial of service attack, compare the MAC address to a database including one or more MAC address entries associated with other received authentication requests, a timestamp associated with each of the one or more MAC address entries, and location information associated with each of the one or more MAC address entries, and detect a denial of service attack based on the comparison. The communications manager 615 may be an example of aspects of the communications manager 910 described herein.

The communications manager 615, or its sub-components, may be implemented in hardware, code (e.g., software or firmware) executed by a processor, or any combination thereof. If implemented in code executed by a processor, the functions of the communications manager 615, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 615, or its sub-components, may be physically located at various positions, including being distributed such that portions of functions are implemented at different physical locations by one or more physical components. In some examples, the communications manager 615, or its sub-components, may be a separate and distinct component in accordance with various aspects of the present disclosure. In some examples, the communications manager 615, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 620 may transmit signals generated by other components of the device. In some examples, the transmitter 620 may be collocated with a receiver 610 in a transceiver module. For example, the transmitter 620 may be an example of aspects of the transceiver 920 described with reference to FIG. 9. The transmitter 620 may utilize a single antenna or a set of antennas.

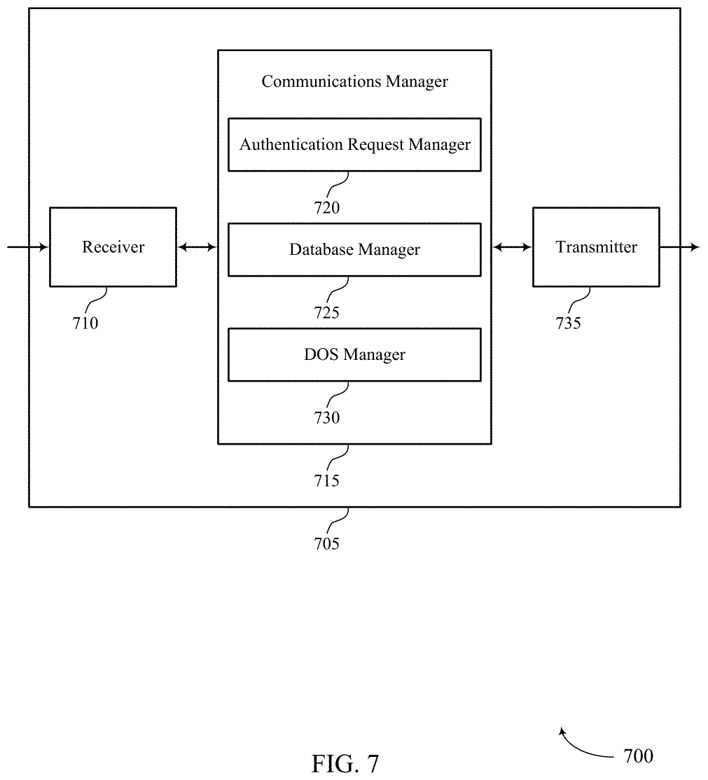

FIG. 7 shows a block diagram 700 of a device 705 that supports DoS attack detection and mitigation in accordance with aspects of the present disclosure. The device 705 may be an example of aspects of a device 605 or a AP 105 as described herein. The device 705 may include a receiver 710, a communications manager 715, and a transmitter 735. The device 705 may also include a processor. Each of these components may be in communication with one another (e.g., via one or more buses).

The receiver 710 may receive information such as packets, user data, or control information associated with various information channels (e.g., control channels, data channels, and information related to DoS attack detection and mitigation, etc.). Information may be passed on to other components of the device. The receiver 710 may be an example of aspects of the transceiver 920 described with reference to FIG. 9. The receiver 710 may utilize a single antenna or a set of antennas.

The communications manager 715 may be an example of aspects of the communications manager 615 as described herein. The communications manager 715 may include an authentication request manager 720, a database manager 725, and a DOS manager 730. The communications manager 715 may be an example of aspects of the communications manager 910 described herein.

The authentication request manager 720 may receive an authentication request corresponding to a MAC address and discard the received authentication request based on the detected denial of service attack. The database manager 725 may compare the MAC address to a database including one or more MAC address entries associated with other received authentication requests, a timestamp associated with each of the one or more MAC address entries, and location information associated with each of the one or more MAC address entries. The DOS manager 730 may detect a denial of service attack based on the comparison.

The transmitter 735 may transmit signals generated by other components of the device. In some examples, the transmitter 735 may be collocated with a receiver 710 in a transceiver module. For example, the transmitter 735 may be an example of aspects of the transceiver 920 described with reference to FIG. 9. The transmitter 735 may utilize a single antenna or a set of antennas.

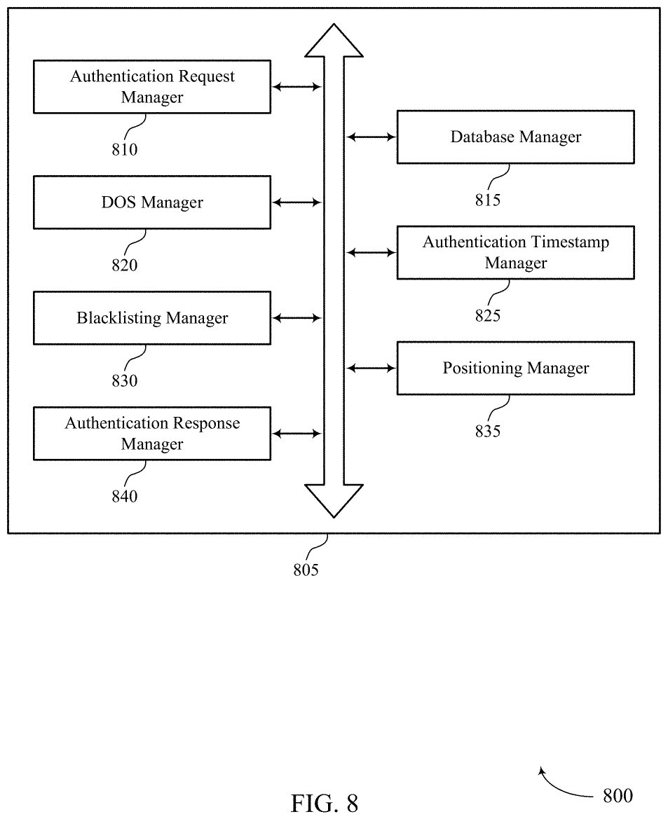

FIG. 8 shows a block diagram 800 of a communications manager 805 that supports DoS attack detection and mitigation in accordance with aspects of the present disclosure. The communications manager 805 may be an example of aspects of a communications manager 615, a communications manager 715, or a communications manager 910 described herein. The communications manager 805 may include an authentication request manager 810, a database manager 815, a DOS manager 820, an authentication timestamp manager 825, a blacklisting manager 830, a positioning manager 835, and an authentication response manager 840. Each of these modules may communicate, directly or indirectly, with one another (e.g., via one or more buses).

The authentication request manager 810 may receive an authentication request corresponding to a MAC address. In some examples, the authentication request manager 810 may discard the received authentication request based on the detected denial of service attack. In some examples, the authentication request manager 810 may receive a second authentication request corresponding to a second MAC address.

The database manager 815 may compare the MAC address to a database including one or more MAC address entries associated with other received authentication requests, a timestamp associated with each of the one or more MAC address entries, and location information associated with each of the one or more MAC address entries. In some examples, the database manager 815 may update the database based on the MAC address and the location associated with the received authentication request. In some examples, adding a new entry corresponding to the MAC address to the database or updating an existing entry corresponding to the MAC address in the database based on whether the database includes the existing entry corresponding to the MAC address. In some examples, the database manager 815 may remove an entry from the database based on the transmitted authentication response message, where the entry is associated with the second MAC address.

In some examples, the database manager 815 may compare the second MAC address to the database. In some examples, the database manager 815 may determine that the second MAC address is unique based on the comparison to the database. In some examples, the database manager 815 may add an entry associated with the second MAC address to the database based on the determination that the second MAC address is unique.

The DOS manager 820 may detect a denial of service attack based on the comparison. In some examples, the DOS manager 820 may determine the MAC address corresponds to one or more other authentication requests associated with the denial of service attack based on the comparison, where the denial of service attack is detected based on the determination. In some examples, the DOS manager 820 may transmit (e.g., to a LEA) an indication of the detected denial of service attack, the MAC address, a location associated the received authentication request, or some combination thereof, based on detecting the denial of service attack.

The authentication timestamp manager 825 may estimate a time duration between a legitimate authentication request and an association request. In some examples, the authentication timestamp manager 825 may determine a first timestamp associated with the received authentication request. In some examples, the authentication timestamp manager 825 may determine a difference between the first timestamp and a second timestamp associated with a previously received authentication request corresponding to the MAC address based on the comparison, where the determination that the MAC address corresponds to the one or more other authentication requests associated with the denial of service attack is based on the difference being less than the time duration. In some examples, the authentication timestamp manager 825 may determine a first timestamp associated with the received second authentication request.

The blacklisting manager 830 may blacklist the MAC address within the database based on the difference being less than the time duration. In some examples, the blacklisting manager 830 may blacklist the one or more other MAC addresses based on the determination that the one or more other MAC addresses are associated with location information that corresponds to the location associated with the received authentication request. In some examples, the blacklisting manager 830 may identify one or more blacklisted MAC addresses based on the database.

The positioning manager 835 may determine a location associated with the received authentication request based on one or more of a RTT associated with the authentication request, an AoA associated with the authentication request, a GPS signal associated with the received authentication request, or a cellular network signal associated with the received authentication request. In some examples, the positioning manager 835 may determine one or more other MAC addresses are associated with location information that corresponds to the location associated with the received authentication request based on the database. In some examples, the positioning manager 835 may determine at least one of the one or more blacklisted MAC addresses are associated with location information that corresponds to the location associated with the received authentication request based on the database, where the denial of service attack is based on the determination that at least one of the one or more blacklisted MAC addresses are associated with location information that corresponds to the location associated with the received authentication request.

The authentication response manager 840 may transmit an authentication response message in response to the received second authentication request based on a first time duration between the first timestamp and a second timestamp being less than or equal to a threshold, where the second timestamp is associated with a previously received authentication request corresponding to the second MAC address in the database. In some cases, the threshold is based on a second time duration between a legitimate authentication request and an association request, a FILS procedure, or a number of connected clients.

FIG. 9 shows a diagram of a system 900 including a device 905 that supports DoS attack detection and mitigation in accordance with aspects of the present disclosure. The device 905 may be an example of or include the components of device 605, device 705, or a AP as described herein. The device 905 may include components for bi-directional voice and data communications including components for transmitting and receiving communications, including a communications manager 910, a network communications manager 915, a transceiver 920, an antenna 925, memory 930, a processor 940, and an inter-station communications manager 945. These components may be in electronic communication via one or more buses (e.g., bus 950).

The communications manager 910 may receive an authentication request corresponding to a MAC address, discard the received authentication request based on the detected denial of service attack, compare the MAC address to a database including one or more MAC address entries associated with other received authentication requests, a timestamp associated with each of the one or more MAC address entries, and location information associated with each of the one or more MAC address entries, and detect a denial of service attack based on the comparison.

The network communications manager 915 may manage communications with the core network (e.g., via one or more wired backhaul links). For example, the network communications manager 915 may manage the transfer of data communications for client devices, such as one or more STAs 115.

The transceiver 920 may communicate bi-directionally, via one or more antennas, wired, or wireless links as described above. For example, the transceiver 920 may represent a wireless transceiver and may communicate bi-directionally with another wireless transceiver. The transceiver 920 may also include a modem to modulate the packets and provide the modulated packets to the antennas for transmission, and to demodulate packets received from the antennas.

In some cases, the wireless device may include a single antenna 925. However, in some cases the device may have more than one antenna 925, which may be capable of concurrently transmitting or receiving multiple wireless transmissions.

The memory 930 may include RAM and ROM. The memory 930 may store computer-readable, computer-executable code 9 35 including instructions that, when executed, cause the processor to perform various functions described herein. In some cases, the memory 930 may contain, among other things, a BIOS which may control basic hardware or software operation such as the interaction with peripheral components or devices.

The processor 940 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In other cases, a memory controller may be integrated into processor 940. The processor 940 may be configured to execute computer-readable instructions stored in a memory to perform various functions (e.g., functions or tasks supporting DoS attack detection and mitigation).

The inter-station communications manager 945 may manage communications with other base stations (e.g., other APs 105), and may include a controller or scheduler for controlling communications with STAs 115 in cooperation with other APs 105. For example, the inter-station communications manager 945 may coordinate scheduling for transmissions to STAs 115 for various interference mitigation techniques such as beamforming or joint transmission. In some examples, the inter-station communications manager 945 may provide an X2 interface within an LTE/LTE-A wireless communication network technology to provide communication between APs 105.

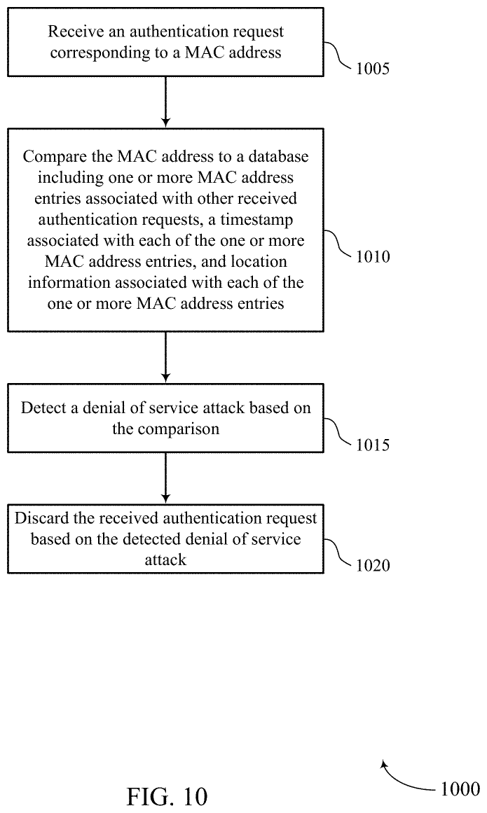

FIG. 10 shows a flowchart illustrating a method 1000 that supports DoS attack detection and mitigation in accordance with aspects of the present disclosure. The operations of method 1000 may be implemented by a AP or its components as described herein. For example, the operations of method 1000 may be performed by a communications manager as described with reference to FIGS. 6 through 9. In some examples, a AP may execute a set of instructions to control the functional elements of the AP to perform the functions described below. Additionally or alternatively, a AP may perform aspects of the functions described below using special-purpose hardware.

At 1005, the AP may receive an authentication request corresponding to a MAC address. The operations of 1005 may be performed according to the methods described herein. In some examples, aspects of the operations of 1005 may be performed by an authentication request manager as described with reference to FIGS. 6 through 9.

At 1010, the AP may compare the MAC address to a database including one or more MAC address entries associated with other received authentication requests, a timestamp associated with each of the one or more MAC address entries, and location information associated with each of the one or more MAC address entries. The operations of 1010 may be performed according to the methods described herein. In some examples, aspects of the operations of 1010 may be performed by a database manager as described with reference to FIGS. 6 through 9.

At 1015, the AP may detect a denial of service attack based on the comparison. The operations of 1015 may be performed according to the methods described herein. In some examples, aspects of the operations of 1015 may be performed by a DOS manager as described with reference to FIGS. 6 through 9.

At 1020, the AP may discard the received authentication request based on the detected denial of service attack. The operations of 1020 may be performed according to the methods described herein. In some examples, aspects of the operations of 1020 may be performed by an authentication request manager as described with reference to FIGS. 6 through 9. As discussed herein, any or all of 1005 through 1020 may be performed at a cloud or other aspects of network, depending on implementation.

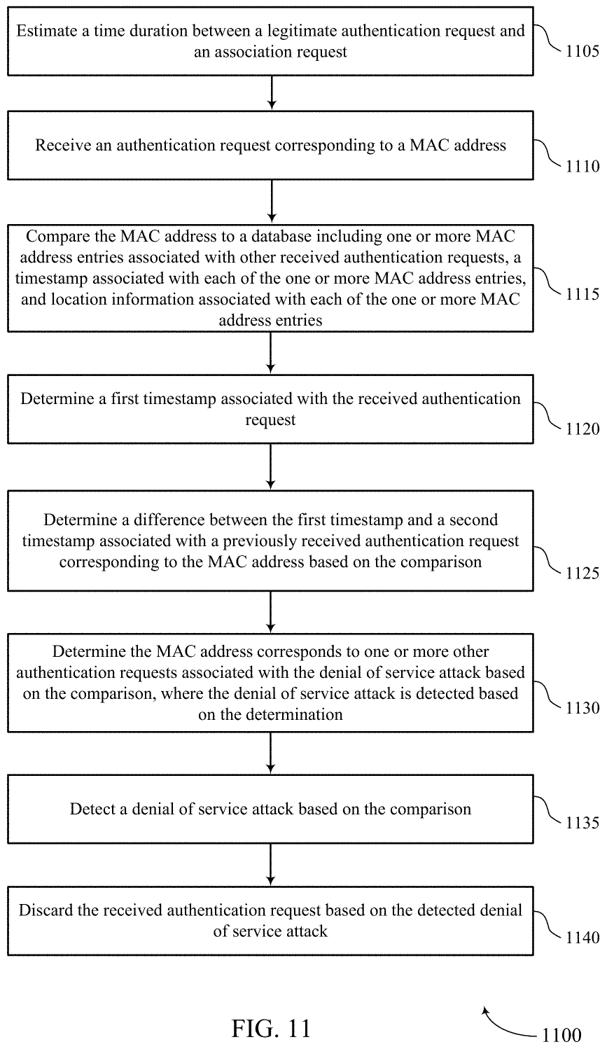

FIG. 11 shows a flowchart illustrating a method 1100 that supports DoS attack detection and mitigation in accordance with aspects of the present disclosure. The operations of method 1100 may be implemented by a AP or its components as described herein. For example, the operations of method 1100 may be performed by a communications manager as described with reference to FIGS. 6 through 9. In some examples, a AP may execute a set of instructions to control the functional elements of the AP to perform the functions described below. Additionally or alternatively, a AP may perform aspects of the functions described below using special-purpose hardware.

At 1105, the AP may estimate a time duration between a legitimate authentication request and an association request. The operations of 1105 may be performed according to the methods described herein. In some examples, aspects of the operations of 1105 may be performed by an authentication timestamp manager as described with reference to FIGS. 6 through 9.

At 1110, the AP may receive an authentication request corresponding to a MAC address. The operations of 1110 may be performed according to the methods described herein. In some examples, aspects of the operations of 1110 may be performed by an authentication request manager as described with reference to FIGS. 6 through 9.

At 1115, the AP may compare the MAC address to a database including one or more MAC address entries associated with other received authentication requests, a timestamp associated with each of the one or more MAC address entries, and location information associated with each of the one or more MAC address entries. The operations of 1115 may be performed according to the methods described herein. In some examples, aspects of the operations of 1115 may be performed by a database manager as described with reference to FIGS. 6 through 9.

At 1120, the AP may determine a first timestamp associated with the received authentication request. The operations of 1120 may be performed according to the methods described herein. In some examples, aspects of the operations of 1120 may be performed by an authentication timestamp manager as described with reference to FIGS. 6 through 9.

At 1125, the AP may determine a difference between the first timestamp and a second timestamp associated with a previously received authentication request corresponding to the MAC address based on the comparison. The operations of 1125 may be performed according to the methods described herein. In some examples, aspects of the operations of 1125 may be performed by an authentication timestamp manager as described with reference to FIGS. 6 through 9.

At 1130, the AP may, in some cases, determine the MAC address corresponds to one or more other authentication requests associated with the denial of service attack based on the comparison (e.g., based on the timestamp difference being less than the time duration). The operations of 1130 may be performed according to the methods described herein. In some examples, aspects of the operations of 1130 may be performed by a DOS manager as described with reference to FIGS. 6 through 9.

At 1135, the AP may detect a denial of service attack based on the determination. The operations of 1135 may be performed according to the methods described herein. In some examples, aspects of the operations of 1135 may be performed by a DOS manager as described with reference to FIGS. 6 through 9.

At 1140, the AP may discard the received authentication request based on the detected denial of service attack. The operations of 1140 may be performed according to the methods described herein. In some examples, aspects of the operations of 1140 may be performed by an authentication request manager as described with reference to FIGS. 6 through 9. As discussed herein, any or all of 1105 through 1140 may be performed at a cloud or other aspects of network, depending on implementation.

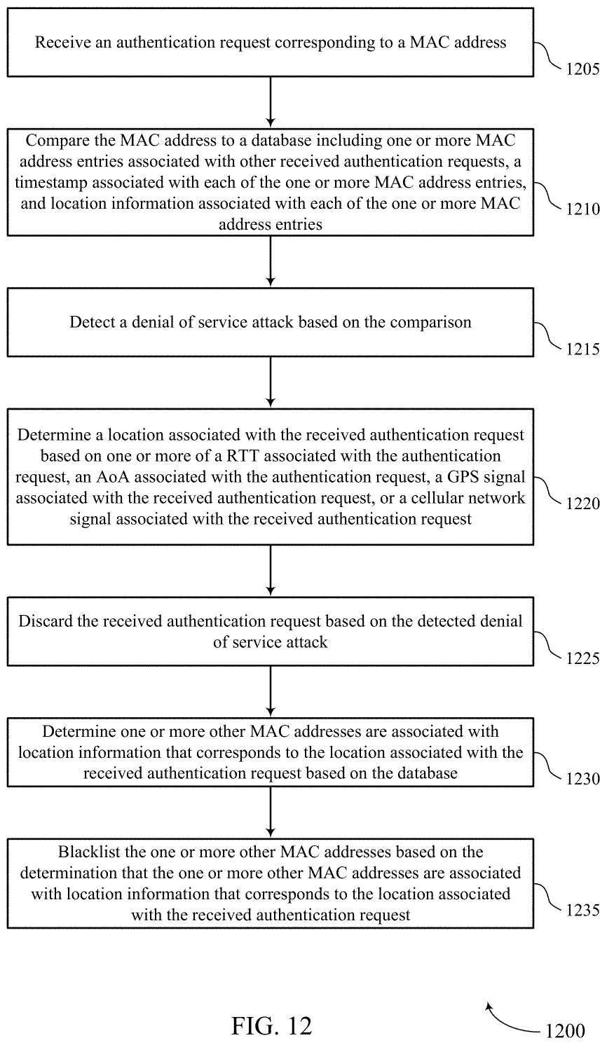

FIG. 12 shows a flowchart illustrating a method 1200 that supports DoS attack detection and mitigation in accordance with aspects of the present disclosure. The operations of method 1200 may be implemented by a AP or its components as described herein. For example, the operations of method 1200 may be performed by a communications manager as described with reference to FIGS. 6 through 9. In some examples, a AP may execute a set of instructions to control the functional elements of the AP to perform the functions described below. Additionally or alternatively, a AP may perform aspects of the functions described below using special-purpose hardware.

At 1205, the AP may receive an authentication request corresponding to a MAC address. The operations of 1205 may be performed according to the methods described herein. In some examples, aspects of the operations of 1205 may be performed by an authentication request manager as described with reference to FIGS. 6 through 9.

At 1210, the AP may compare the MAC address to a database including one or more MAC address entries associated with other received authentication requests, a timestamp associated with each of the one or more MAC address entries, and location information associated with each of the one or more MAC address entries. The operations of 1210 may be performed according to the methods described herein. In some examples, aspects of the operations of 1210 may be performed by a database manager as described with reference to FIGS. 6 through 9.

At 1215, the AP may detect a denial of service attack based on the comparison. The operations of 1215 may be performed according to the methods described herein. In some examples, aspects of the operations of 1215 may be performed by a DOS manager as described with reference to FIGS. 6 through 9.

At 1220, the AP may determine a location associated with the received authentication request based on one or more of a round trip time (RTT) associated with the authentication request, an angle of approach (AoA) associated with the authentication request, a GPS signal associated with the received authentication request, or a cellular network signal associated with the received authentication request. The operations of 1220 may be performed according to the methods described herein. In some examples, aspects of the operations of 1220 may be performed by a positioning manager as described with reference to FIGS. 6 through 9.

At 1225, the AP may discard the received authentication request based on the detected denial of service attack. The operations of 1225 may be performed according to the methods described herein. In some examples, aspects of the operations of 1225 may be performed by an authentication request manager as described with reference to FIGS. 6 through 9.

At 1230, the AP may determine one or more other MAC addresses are associated with location information that corresponds to the location associated with the received authentication request based on the database. The operations of 1230 may be performed according to the methods described herein. In some examples, aspects of the operations of 1230 may be performed by a positioning manager as described with reference to FIGS. 6 through 9.

At 1235, the AP may blacklist the one or more other MAC addresses based on the determination that the one or more other MAC addresses are associated with location information that corresponds to the location associated with the received authentication request. The operations of 1235 may be performed according to the methods described herein. In some examples, aspects of the operations of 1235 may be performed by a blacklisting manager as described with reference to FIGS. 6 through 9. As discussed herein, any or all of 1205 through 1235 may be performed at a cloud or other aspects of network, depending on implementation.

It should be noted that the methods described herein describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communications system 100 and 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communications, comprising:
receiving an authentication request corresponding to a medium access control (MAC) address;
comparing the MAC address to a database comprising one or more MAC address entries associated with other received authentication requests, a timestamp associated with each of the one or more MAC address entries, and location information associated with each of the one or more MAC address entries;
detecting a denial of service attack based at least in part on the comparison; and
discarding the received authentication request based at least in part on the detected denial of service attack.

2. The method of claim 1, further comprising:
determining the MAC address corresponds to one or more other authentication requests associated with the denial of service attack based at least in part on the comparison, wherein the denial of service attack is detected based on the determination.

3. The method of claim 2, further comprising:
estimating a time duration between a legitimate authentication request and an association request;
determining a first timestamp associated with the received authentication request; and
determining a difference between the first timestamp and a second timestamp associated with a previously received authentication request corresponding to the MAC address based at least in part on the comparison, wherein the determination that the MAC address corresponds to the one or more other authentication requests associated with the denial of service attack is based at least in part on the difference being less than the time duration.

4. The method of claim 3, further comprising:
blacklisting the MAC address within the database based at least in part on the difference being less than the time duration.

5. The method of claim 1, further comprising:
determining a location associated with the received authentication request based at least in part on one or more of a round trip time (RTT) associated with the authentication request, an angle of approach (AoA) associated with the authentication request, a global positioning system (GPS) signal associated with the received authentication request, or a cellular network signal associated with the received authentication request.

6. The method of claim 5, further comprising:
determining one or more other MAC addresses are associated with location information that corresponds to the location associated with the received authentication request based at least in part on the database; and
blacklisting the one or more other MAC addresses based at least in part on the determination that the one or more other MAC addresses are associated with location information that corresponds to the location associated with the received authentication request.

7. The method of claim 5, further comprising:
identifying one or more blacklisted MAC addresses based at least in part on the database; and
determining at least one of the one or more blacklisted MAC addresses are associated with location information that corresponds to the location associated with the received authentication request based at least in part on the database, wherein the denial of service attack is based at least in part on the determination that at least one of the one or more blacklisted MAC addresses are associated with location information that corresponds to the location associated with the received authentication request.

8. The method of claim 5, further comprising:
updating the database based at least in part on the MAC address and the location associated with the received authentication request.

9. The method of claim 8, wherein updating the database comprises:
adding a new entry corresponding to the MAC address to the database or updating an existing entry corresponding to the MAC address in the database based at least in part on whether the database comprises the existing entry corresponding to the MAC address.

10. The method of claim 1, further comprising:
receiving a second authentication request corresponding to a second MAC address;
determining a first timestamp associated with the received second authentication request; and
transmitting an authentication response message in response to the received second authentication request based at least in part on a first time duration between the first timestamp and a second timestamp being less than or equal to a threshold, wherein the second timestamp is associated with a previously received authentication request corresponding to the second MAC address in the database.

11. The method of claim 10, further comprising:
removing an entry from the database based at least in part on the transmitted authentication response message, wherein the entry is associated with the second MAC address.

12. The method of claim 10, wherein the threshold is based at least in part on a second time duration between a legitimate authentication request and an association request, a fast initial link setup (FILS) procedure, or a number of connected clients.

13. The method of claim 10, further comprising:
comparing the second MAC address to the database;
determining that the second MAC address is unique based at least in part on the comparison to the database; and
adding an entry associated with the second MAC address to the database based at least in part on the determination that the second MAC address is unique.

14. The method of claim 1, further comprising:
transmitting an indication of the detected denial of service attack, the MAC address, a location associated the received authentication request, or some combination thereof, based at least in part on detecting the denial of service attack.

15. The method of claim 14, wherein the indication is transmitted to a law enforcement agency.

16. An apparatus for wireless communications, comprising:
a processor,
memory coupled with the processor; and
instructions stored in the memory and executable by the processor to cause the apparatus to:
receive an authentication request corresponding to a medium access control (MAC) address;
compare the MAC address to a database comprising one or more MAC address entries associated with other received authentication requests, a timestamp associated with each of the one or more MAC address entries, and location information associated with each of the one or more MAC address entries;
detect a denial of service attack based at least in part on the comparison; and
discard the received authentication request based at least in part on the detected denial of service attack.

17. The apparatus of claim 16, wherein the instructions are further executable by the processor to cause the apparatus to:
determine the MAC address corresponds to one or more other authentication requests associated with the denial of service attack based at least in part on the comparison, wherein the denial of service attack is detected based on the determination.

18. The apparatus of claim 17, wherein the instructions are further executable by the processor to cause the apparatus to:
estimate a time duration between a legitimate authentication request and an association request;
determine a first timestamp associated with the received authentication request; and
determine a difference between the first timestamp and a second timestamp associated with a previously received authentication request corresponding to the MAC address based at least in part on the comparison, wherein the determination that the MAC address corresponds to the one or more other authentication requests associated with the denial of service attack is based at least in part on the difference being less than the time duration.

19. The apparatus of claim 16, wherein the instructions are further executable by the processor to cause the apparatus to:
determine a location associated with the received authentication request based at least in part on one or more of a round trip time (RTT) associated with the authentication request, an angle of approach (AoA) associated with the authentication request, a global positioning system (GPS) signal associated with the received authentication request, or a cellular network signal associated with the received authentication request.

20. An apparatus for wireless communications, comprising:
means for receiving an authentication request corresponding to a medium access control (MAC) address;
means for comparing the MAC address to a database comprising one or more MAC address entries associated with other received authentication requests, a timestamp associated with each of the one or more MAC address entries, and location information associated with each of the one or more MAC address entries;
means for detecting a denial of service attack based at least in part on the comparison; and
means for discarding the received authentication request based at least in part on the detected denial of service attack.
